(19) United States
(12) Patent Application Publication
(10) Pub. No.: US 2013/0275956 A1
(43) Pub. Date: Oct. 17, 2013

(54) FIRMWARE UPGRADE METHOD AND SYSTEM AND TERMINAL DEVICE USING THE METHOD

(71) Applicants: CHUN-CHIEH LAI, Tu-Cheng (TW); HUAI-CHIH FAN, Tu-Cheng (TW)

(72) Inventors: CHUN-CHIEH LAI, Tu-Cheng (TW); HUAI-CHIH FAN, Tu-Cheng (TW)

(73) Assignee: HON HAI PRECISION INDUSTRY CO., LTD., Tu-Cheng (TW)

(21) Appl. No.: 13/553,801

(22) Filed: Jul. 19, 2012

(30) Foreign Application Priority Data
Apr. 17, 2012 (TW) 101113676

(51) Int. Cl. G06F 9/44

(52) U.S. Cl. 717/170

(57) ABSTRACT

A firmware upgrade method is applied to a terminal device in a subnet. A first terminal device in the subnet downloads a firmware upgrade file from a remote server and broadcasts a first packet to at least a second terminal device in the subnet. The second terminal device in the subnet sends an upgrade request to the first terminal device when the received first packet includes the latest firmware version and upgrade time. The first terminal device then transmits the firmware upgrade file to the second terminal device in the subnet according to a header field and an IP header field of the first packet. The second terminal device retrieves the firmware upgrade file. Each of the first and second terminal devices executes the firmware upgrade file to complete the firmware upgrade.

### BACKGROUND

1. Technical Field

The present disclosure relates to network communications, and more particularly to a firmware upgrade method and system and a terminal device using the method.

2. Description of Related Art

Network devices may upload or download kernel files using Trivial File Transfer Protocol (TFTP).

TFTP is a file transfer protocol notable for its simplicity. It is generally used for automated transfer of configuration or boot files between machines in a local environment. Compared to File Transfer Protocol (FTP), TFTP is extremely limited; TFTP provides no authentication, and is rarely used interactively by a user. Thus TFTP is appropriate for firmware upgrades.

FIG. 1 shows a block diagram of a firmware upgrade system of related art.

The firmware upgrade system comprises a TFTP server 110 and subnets 120 and 130. The subnet 120 comprises a router 125 and terminal devices 1201, 1202 and 1203. The subnet 130 comprises a router 135 and terminal devices 1301, 1302 and 1303.

When a new version of firmware is provided, the TFTP server 110 sends an upgrade notification to all the terminal devices 1201, 1202, 1203, 1301, 1302 and 1303.

Alternatively, each of the terminal devices 1201, 1202, 1203, 1301, 1302 and 1303 may query whether the TFTP server 110 can provide a new version of firmware.

When the new version of firmware is provided, each of the terminal devices 1201, 1202, 1203, 1301, 1302 and 1303 sends a downloading request to the TFTP server 110 via the routers 125 and 135 and, when authorized by the TFTP server 110, retrieves the new firmware from the TFTP server 110 for firmware upgrade.

However, the downloading of firmware from the TFTP server 110 by each of the terminal devices 1201, 1202, 1203, 1301, 1302 and 1303 results in heavy loading to the TFTP server 110. This is liable to cause any of a variety of problems in the firmware upgrade system, and inconvenience the network management or a multiple system operator (MSO) running the network.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 shows a block diagram of a firmware upgrade system of related art.

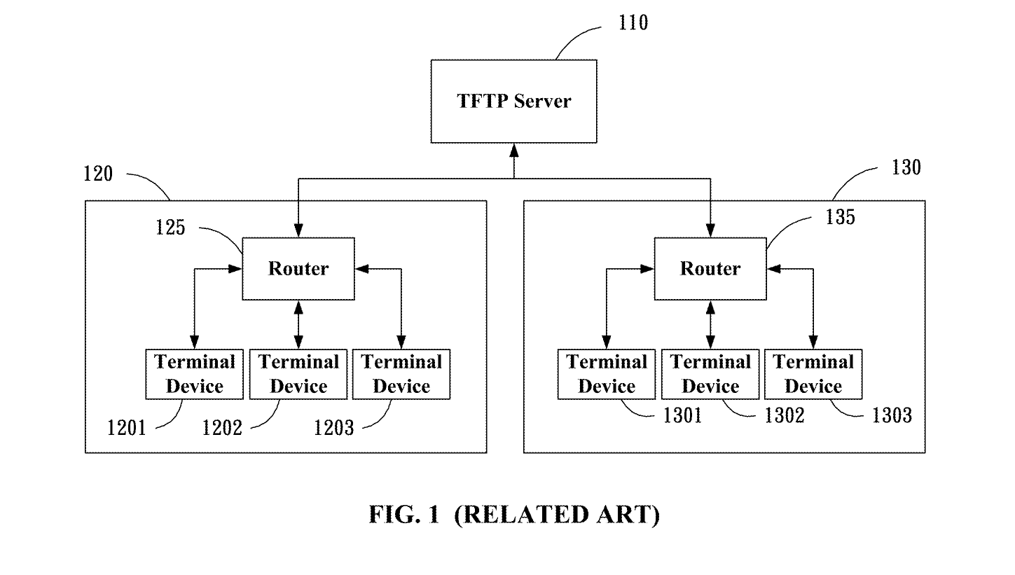

FIG. 2 shows a block diagram of an exemplary embodiment of a firmware upgrade system in accordance with the present disclosure, the firmware upgrade system including a plurality of terminal devices.

FIG. 3 shows a diagram of an exemplary format of a data packet used by each of the terminal devices of FIG. 2, in accordance with the present disclosure.

FIG. 4 shows a flowchart of an exemplary embodiment of a firmware upgrade method in accordance with the present disclosure.

FIG. 5 shows a block diagram of an exemplary embodiment of one of the terminal devices of FIG. 2, in accordance with the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

A firmware upgrade method of the present disclosure implements a subnet-based firmware upgrade of a terminal device. This method decreases data traffic generated by firmware upgrade of terminal devices within a single large subnet. That is, the data traffic caused by the firmware upgrade of the terminal devices can be greatly reduced.

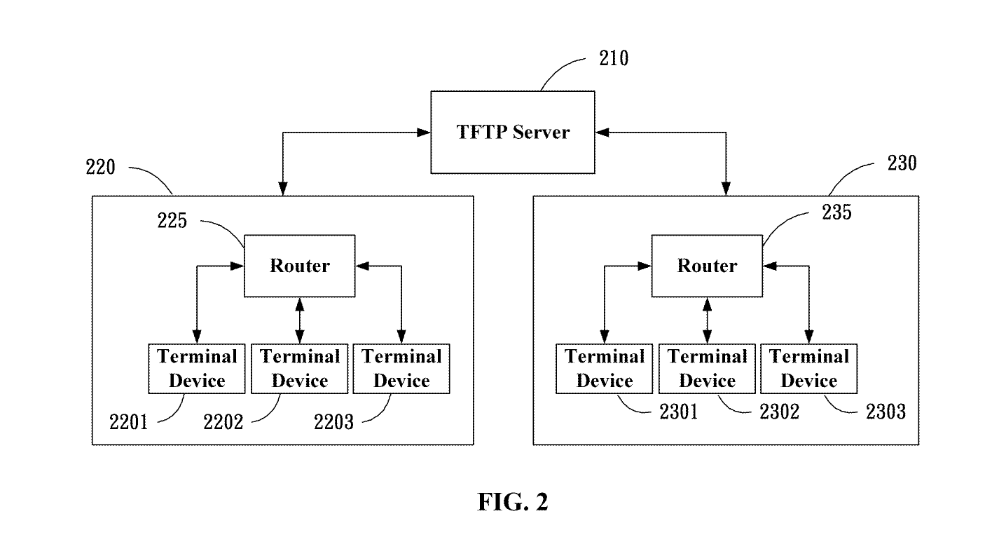

FIG. 2 shows a block diagram of an exemplary embodiment of a firmware upgrade system in accordance with the present disclosure.

The firmware upgrade system comprises a Trivial File Transfer Protocol (TFTP) server 210 and at least two subnets 220 and 230. The subnet 220 comprises a router 225 and at least three terminal devices 2201, 2202 and 2203. The subnet 230 comprises a router 235 and at least three terminal devices 2301, 2302 and 2303.

When a new version of firmware is provided, the TFTP server 210 sends an upgrade notification to one of the terminal devices 2201, 2202 and 2203 (the terminal device 2201, for example) and one of the terminal devices 2301, 2302 and 2303 (the terminal device 2301, for example) according to a preset rule. Alternatively, one of the terminal devices 2201, 2202 and 2203 (the terminal device 2201, for example) and one of the terminal devices 2301, 2302 and 2303 (the terminal device 2301, for example) query whether the TFTP server 210 can provide a new version of firmware.

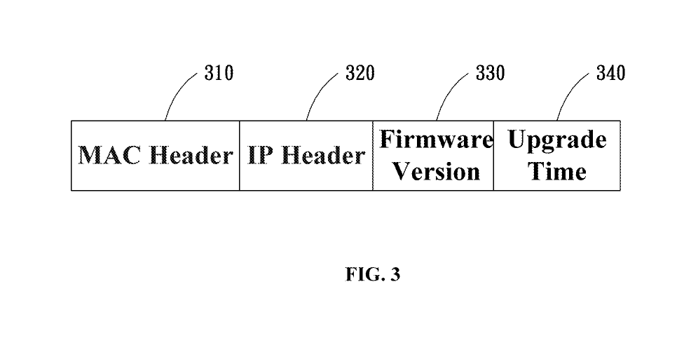

Taking the subnet 220 for example, when a new version of firmware is provided by the TFTP server 210, one of the terminal devices 2201, 2202 and 2203 (the terminal device 2201, for example) sends a downloading request to the TFTP server 210 via the router 225 and, when authorized by the TFTP server 210, retrieves new firmware from the TFTP server 210, and executes the new firmware. Typically, the terminal device 2201 needs to reboot after executing the new firmware. The terminal device 2201 then broadcasts a data packet to the terminal devices 2202 and 2203 in the subnet 220. As shown in FIG. 3, the packet comprises a Media Access Control (MAC) header field 310, an Internet Protocol (IP) header field 320, a firmware version field 330, and an upgrade time field 340.

The MAC header field 310 stores a MAC address of the terminal device 2201. The IP header field 320 stores an IP address of the terminal device 2201. The firmware version field 330 stores information on the current firmware version (i.e., the new firmware now) residing in the terminal device 2201. The upgrade time field 340 stores a timestamp associated with the current firmware version (i.e., the new firmware). The timestamp can, for example, be a date and a time when the terminal device 2201 retrieved the new firmware from the TFTP server 210. Alternatively, the timestamp can be some other kind of unique time-based mark or symbol that identifies the new firmware.

Each of the terminal devices 2201, 2202 and 2203 determines whether any packet from the other two terminal devices 2202, 2203 and/or 2201 has been received. If no packet is received, each of the terminal devices 2201, 2202 and 2203 waits for a preset interval time, and then rebroadcasts another packet to the other two terminal devices 2202, 2203 and/or 2201. If packets from either or both of the other two terminal devices 2202, 2203 and/or 2201 are then received, each of the terminal devices 2201, 2202 and 2203 determines whether any one of the received packets includes the latest firmware version and upgrade time. Each of the terminal devices 2201, 2202 and 2203 makes the determination by comparing the firmware version and upgrade time of the received packet with the firmware version and upgrade time of the firmware currently residing in the terminal device 2201, 2202 or 2203.

If none of the received packets includes the latest firmware version and upgrade time, each of the terminal devices 2201, 2202 and 2203 waits for a preset interval time, and then rebroadcasts another packet to the other two terminal devices 2202, 2203 and/or 2201.

When a packet from the terminal device 2201, for example, includes the latest firmware version and upgrade time, each of the terminal devices 2202 and 2203 sends an upgrade request to the terminal device 2201 according to the MAC header field 310 and the IP header field 320 of the packet from the terminal device 2201.

Then each of the terminal devices 2202 and 2203 retrieves a firmware upgrade file (i.e. the new firmware) from the terminal device 2201, and executes the firmware upgrade file to complete the firmware upgrade. Typically, each of the terminal devices 2202 and 2203 needs to reboot after the firmware upgrade is completed.

In one alternative embodiment, after the terminal device 2201 retrieves the new firmware from the TFTP server 210, the terminal device 2201 can broadcast a data packet containing the information of the new firmware to the terminal devices 2202 and 2203 in the subnet 220 before the terminal device 2201 itself executes the new firmware. In a similar alternative embodiment, the terminal device 2201 can broadcast a data packet containing the information of the new firmware to the terminal devices 2202 and 2203 in the subnet 220 at the same time as the terminal device 2201 itself executing the new firmware. In another similar alternative embodiment, each of the terminal devices 2202 and 2203 can broadcast a data packet containing the information of the new firmware to the other terminal devices 2201 and 2203, and 2201 and 2202, respectively, in the subnet 220 before each of the terminal devices 2202 and 2203 itself executes the new firmware. In yet another similar alternative embodiment, each of the terminal devices 2202 and 2203 can broadcast a data packet containing the information of the new firmware to the other terminal devices 2201 and 2203, and 2201 and 2202, respectively, in the subnet 220 at the same time as each of the terminal devices 2202 and 2203 itself executing the new firmware.

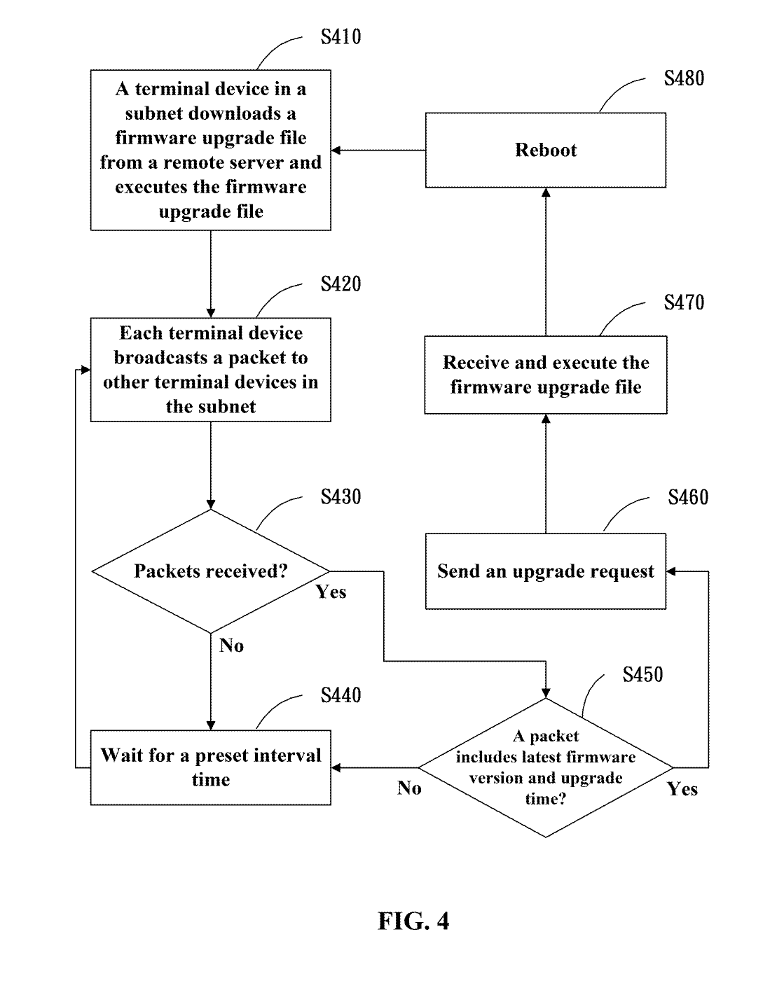

FIG. 4 shows a flowchart of an exemplary embodiment of a firmware upgrade method applied to terminal devices in a subnet in accordance with the present disclosure.

In step S410, a first terminal device (the terminal device 2201, for example) in a subnet (the subnet 220, for example) receives a user instruction, downloads a firmware upgrade file from a remote server (the TFTP server 210, for example) according to the user instruction, and executes the firmware upgrade file.

In step S420, the first terminal device (2201) in the subnet (220) broadcasts a first packet to a second terminal device (the terminal device 2202, for example) and to a third terminal device (the terminal device 2203, for example). In the meantime, the second terminal device (2202) in the subnet (220) broadcasts a second packet to the first terminal device (2201) and to the third terminal device (2203), and the third terminal device (2203) in the subnet (220) broadcasts a third packet to the first terminal device (2201) and to the second terminal device (2202).

Each of the first, second and third packets comprises the MAC header field 310, the IP header field 320, the firmware version field 330 and the upgrade time field 340, as shown in FIG. 3.

The MAC header field 310 stores a MAC address of the terminal device (2201, 2202 or 2203). The IP header field 320 stores an IP address of the terminal device (2201, 2202 or 2203). The firmware version field 330 stores information on the current firmware version residing in the terminal device (2201, 2202 or 2203). The upgrade time field 340 stores the timestamp associated with the current firmware version.

In step S430, each of the first, second and third terminal devices (2201, 2202 and 2203) in the subnet (220) determines whether a packet from either or both of the other two terminal devices (2202, 2203 and/or 2201) has been received. If no packet is received at all by any one of the first, second and third terminal devices (2201, 2202 and 2203), then each such first, second and third terminal device (2201, 2202 and 2203) proceeds to step S440. If a packet from either or both of the other two terminal devices (2202, 2203 and/or 2201) is received by any one of the first, second and third terminal devices (2201, 2202 and 2203), then each such receiving first, second and third terminal device (2201, 2202 and 2203) proceeds to step S450.

In step S440, each first, second and/or third terminal device (2201, 2202 and/or 2203) waits for a preset interval time, and then returns to step S420.

In step S450, each first, second and/or third terminal device (2201, 2202 and/or 2203) determines whether any one of the received packets includes the latest firmware version and upgrade time. If no packet received includes the latest firmware version and upgrade time, each first, second and/or third terminal device (2201, 2202 and 2203) proceeds to step S440. If for example the first packet from the first terminal device (2201) includes the latest firmware version and upgrade time, and such first packet is received by the second and third terminal devices (2202 and 2203), then each of the second and third terminal devices (2202 and 2203) proceeds to step S460.

In step S460, the second and third terminal devices (2202 and 2203) send upgrade requests (a second upgrade request and a third upgrade request, for example) to the first terminal device (2201) according to the MAC header field 310 and the IP header field 320 of the first packet.

In step S470, when the second and third upgrade requests are received by the first terminal device (2201), the first terminal device (2201) transmits to the second and third terminal devices (2202 and 2203) the firmware upgrade file downloaded from the remote server (210). After the second and third terminal devices (2202 and 2203) receive the transmission from the first terminal device (2201), the second and third terminal devices (2202 and 2203) execute the firmware upgrade file.

In step S480, when the firmware upgrade is completed, the second and third terminal devices (2202 and 2203) are rebooted.

After step S480 has been completed, the procedure can be considered to have been completed, and the procedure can be considered to return to step S410 for a next cycle of the procedure to occur in future.

Note that after all of on-line terminal devices (2201, 2202 and/or 2203) in the subnet (220) have had their firmware upgraded, the on-line terminal devices (2201, 2202 and/or 2203) subsequently broadcast information related to the upgraded firmware version and the associated timestamp within the subnet (220). Thus, off-line terminal devices (2201, 2202 and/or 2203) in the subnet (220) can subsequently retrieve the firmware upgrade file from any one terminal device (2201, 2202 or 2203) having the latest firmware version according to the broadcast information, when such off-line terminal devices (2201, 2202 and/or 2203) become on-line.

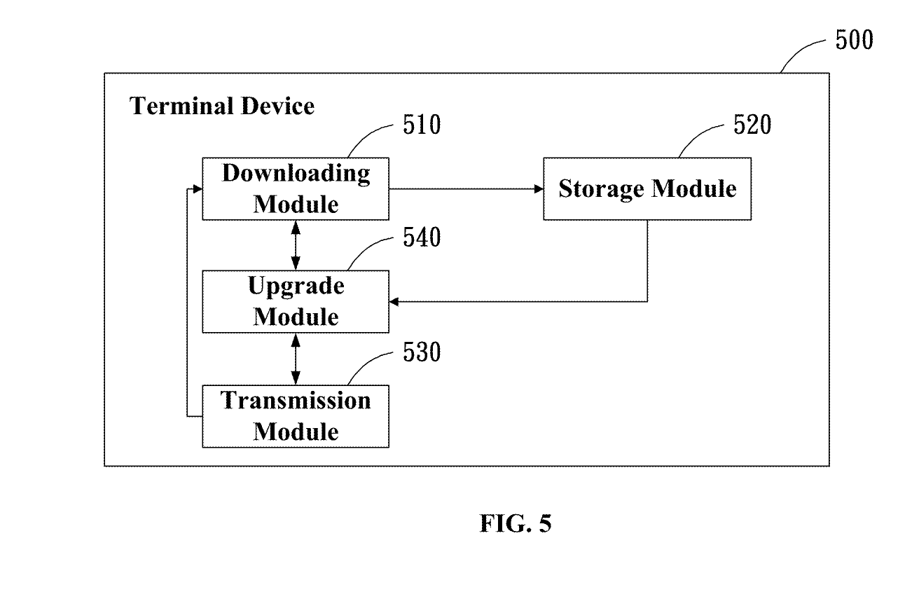

FIG. 5 shows a block diagram of an exemplary embodiment of one of the terminal devices 2201, 2202, 2203, 2301, 2302 and 2303, which resides in a corresponding subnet 220 or 230, in accordance with the present disclosure.

The exemplary terminal device is labeled with the reference numeral 500, and comprises a downloading module 510, a storage module 520, a transmission module 530 and an upgrade module 540. The modules can be implemented in hardware and/or software. In practice, the terminal device 500 can be any one of a wide variety of terminals such as a router, a Wireless Fidelity (WiFi) access point, or any network device that needs firmware upgrade.

The downloading module 510 queries whether a firmware upgrade file is available from a remote server (the TFTP server 210, for example). When the firmware upgrade file is available, the downloading module 510 retrieves (i.e., downloads) the firmware upgrade file from the remote server, and stores the firmware upgrade file in the storage module 520. Alternatively, when the remote server is provided with a firmware upgrade file, the remote server sends (outputs) an upgrade notification to the downloading module 510, and transmits the firmware upgrade file to the downloading module 510.

The transmission module 530 broadcasts a packet to other terminal devices residing in the same subnet. As shown in FIG. 3, the packet comprises the MAC header field 310, the IP header field 320, the firmware version field 330 and the upgrade time field 340.

The MAC header field 310 stores the MAC address of the terminal device 500. The IP header field 320 stores the IP address of the terminal device 500. The firmware version field 330 stores information on the current firmware version residing in the terminal device 500. The upgrade time field 340 stores the timestamp associated with the current firmware version.

Further, while the packet is being broadcasted from the transmission module 530 to the other terminal devices residing in the same subnet, the transmission module 530 receives packets from the other terminal devices residing in the same subnet, and determines whether any one of the received packets includes the latest firmware version and upgrade time. If none of the received packets includes the latest firmware version and upgrade time, the transmission module 530 waits for a preset interval, and rebroadcasts another packet to the other terminal devices and, in the meantime, receives new packets from the other terminal devices. When one of the received packets includes the latest firmware version and upgrade time, the transmission module 530 sends an upgrade notification to the upgrade module 540.

When the upgrade module 540 receives the upgrade notification from the transmission module 530, the upgrade module 540 sends an upgrade request to the terminal device that broadcasted the packet that included the latest firmware version and upgrade time, according to the MAC header field 310 and the IP header field 320 contained in that packet. The upgrade module 540 then enables the downloading module 510 to retrieve (i.e., download) the firmware upgrade file from the terminal device, and to store the firmware upgrade file in the storage module 520. The upgrade module 540 subsequently executes the firmware upgrade file to complete the firmware upgrade of the terminal device 500.

The exemplary firmware upgrade method of the present disclosure enables each of the terminal devices in a subnet to, once the terminal device has had its firmware upgraded, broadcast upgrade information to the other terminal devices in the same subnet. Thus each already-upgraded terminal device can act as a TFTP server in the subnet to provide a firmware upgrade service for the other terminal devices in the subnet. As a result, the occurrence and amount of data traffic is distributed and localized, being restricted within the subnet where the terminal devices are residing. Thus, less data loading on the TFTP server can be achieved, for smooth management of the firmware upgrade system by, say, a multiple system operator (MSO).

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A firmware upgrade method applied to terminal devices, the method comprising:
in a subnet comprising a first terminal device, a second terminal device and a third terminal device, downloading, by the first terminal device, a firmware upgrade file from a remote server according to a user instruction;
broadcasting, by the first terminal device, a first packet to the second terminal device and the third terminal device, broadcasting, by the second terminal device, a second packet to the first terminal device and the third terminal device, and broadcasting, by the third terminal device, a third packet to the first terminal device and the second terminal device, wherein each of the first, second and third packets comprises information on a current version of firmware residing in the respective first, second and third terminal device and an upgrade time, and the upgrade time is a timestamp associated with the current version of the firmware;
when the first packet comprises a latest firmware version and upgrade time among the firmware versions and upgrade times of all of the first, second and third terminal devices, sending, by the second and third terminal devices, a second upgrade request and a third upgrade request, respectively, to the first terminal device;
transmitting, by the first terminal device, the firmware upgrade file to the second and third terminal devices according to the second and third upgrade requests; and
executing, by each of the first, second and third terminal devices, the firmware upgrade file to complete the firmware upgrade.

2. The firmware upgrade method of claim 1, further comprising:
determining, by each of the first, second and third terminal devices in the subnet, whether a packet from any one or more of the other terminal devices in the subnet has been received; and
if no packet is received at all by any one of the first, second and third terminal devices, each such first, second and third terminal device waiting for a preset interval time, and then broadcasting a new packet to the other terminal devices in the subnet and receiving new packets from the other terminal devices in the subnet in the meantime.

3. The firmware upgrade method of claim 1, further comprising:
determining, by the second terminal device, whether any packet received from any of the other terminal devices comprises the latest firmware version and upgrade time; and
when no packet received by the second terminal device comprises the latest firmware version and upgrade time, the second terminal device waiting for a preset interval time, and then receiving a new packet from each of the other terminal devices.

4. The firmware upgrade method of claim 1, wherein each of the first, second and third packets comprises a media access control (MAC) header field, an Internet protocol (IP) header field, a firmware version field, and an upgrade time field.

5. The firmware upgrade method of claim 4, wherein the firmware version field stores the information on the current firmware version residing in the respective first, second or third terminal device.

6. The firmware upgrade method of claim 5, wherein the upgrade time field stores the timestamp associated with the current firmware version residing in the respective first, second or third terminal device.

7. A firmware upgrade system, comprising:
a remote server, operable to store a firmware upgrade file; and
at least a subnet comprising at least a first terminal device, a second terminal device and a third terminal device, wherein:
the first terminal device downloads the firmware upgrade file from the remote server according to a user instruction;
the first terminal device broadcasts a first packet to the second terminal device and the third terminal device, the second terminal device broadcasts a second packet to the first terminal device and the third terminal device, and the third terminal device broadcasts a third packet to the first terminal device and the second terminal device, wherein each of the first, second and third packets comprises information on a current version of firmware residing in the respective first, second and third terminal device and an upgrade time, and the upgrade time is a timestamp associated with the current version of the firmware;
when the first packet comprises a latest firmware version and upgrade time among the firmware versions and upgrade times of all of the at least a first terminal device, a second terminal device and a third terminal device, the second and third terminal devices send a second upgrade request and a third upgrade request, respectively, to the first terminal device;
the first terminal device transmits the firmware upgrade file to the second and third terminal devices according to the second and third upgrade requests; and
each of the first, second and third terminal devices executes the firmware upgrade file to complete the firmware upgrade.

8. The firmware upgrade system of claim 7, wherein each first, second and third terminal device in the subnet determines whether a packet from any one or more of the other terminal devices in the subnet has been received, and if no packet is received at all by any one of the first, second and third terminal devices, each such terminal device waits for a preset interval time, and then broadcasts a new packet to the other terminal devices in the subnet and receives new packets from the other terminal devices in the subnet in the meantime.

9. The firmware upgrade system of claim 7, wherein the second terminal device determines whether any packet received from any of the other terminal devices comprises the latest firmware version and upgrade time, and when no packet received comprises the latest firmware version and upgrade time, the second terminal device waits for a preset interval time, and then receives a new packet from each of the other terminal devices.

10. The firmware upgrade system of claim 7, wherein each of the first, second and third packets comprises a media access control (MAC) header field, an Internet protocol (IP) header, a firmware version field and an upgrade time field.

11. The firmware upgrade system of claim 10, wherein the firmware version field stores the information on the current firmware version residing in the respective first, second or third terminal device.

12. The firmware upgrade system of claim 11, wherein the upgrade time field stores the timestamp associated with the current firmware version residing in the respective first, second or third terminal device.

13. A terminal device residing in a subnet, comprising:
a storage module, operable to store a first firmware upgrade file;
a downloading module, operable to query whether a new firmware upgrade file is available from a remote server, and when the new firmware upgrade file is available, operable to retrieve the new firmware upgrade file from the remote server and store the new firmware upgrade file in the storage module;
a transmission module, operable to broadcast a first packet to one or more other terminal devices residing in the subnet and, when a second packet comprising information on a latest firmware version and upgrade time is received from a second terminal device of the other terminal devices, operable to output an upgrade notification; and
an upgrade module, operable to receive the upgrade notification from the transmission module, and in response to the upgrade notification, operable to send an upgrade request to the second terminal device and enable the downloading module to retrieve a second firmware upgrade file from the second terminal device according to the upgrade request and store the second firmware upgrade file in the storage module, and further operable to retrieve the second firmware upgrade file from the storage module and execute the second firmware upgrade file to complete the firmware upgrade of the terminal device.

14. The terminal device of claim 13, wherein the transmission module receives packets broadcasted by the other terminal devices residing in the subnet, determines whether any one of the received packets comprises the latest firmware version and upgrade time, and if none of the received packets comprises the latest firmware version and upgrade time, the transmission module broadcasts a third packet to the other terminal devices residing in the subnet and receives new packets from the other terminal devices in the subnet in the meantime.

15. The terminal device of claim 13, wherein each of the first and second packets comprises a media access control (MAC) header field, an Internet protocol (IP) header field, a firmware version field, and an upgrade time field.

16. The terminal device of claim 15, wherein the downloading module retrieves the second firmware upgrade file from the second terminal device according to the MAC header field and the IP header field of the second packet.

17. The terminal device of claim 15, wherein the firmware version field stores information on a current firmware version residing in the respective terminal device sending the respective first or second packet.

18. The terminal device of claim 17, wherein the upgrade time field stores a timestamp associated with the current firmware version residing in the respective terminal device sending the respective first or second packet.
